(19) United States
(12) Patent Application Publication
(10) Pub. No.: US 2026/0168547 A1
(43) Pub. Date: Jun. 18, 2026

(54) SUPPORT AND SLIDING BRACKET AND STUB AXLE ASSEMBLY AND FLOATING TYPE BRAKE CALIPER ASSEMBLY

(71) Applicant: Brembo N.V., Bergamo (IT)

(72) Inventors: Lorenzo NESSI, Bergamo (IT); Davide BOLESO, Bergamo (IT); Fabio SCOTTI, Bergamo (IT)

(21) Appl. No.: 19/417,843

(22) Filed: Dec. 12, 2025

(30) Foreign Application Priority Data
Dec. 13, 2024 (IT) 102024000028431

(51) Int. Cl. F16D 65/00; F16D 55/00; F16D 55/227

(52) U.S. Cl. CPC F16D 65/0056; F16D 55/227; F16D 65/0075; F16D 2055/0008; F16D 2055/002

(57) ABSTRACT

The object of the present invention is a support and sliding bracket (1) and stub axle (25) assembly for a floating type brake caliper assembly, as well as a floating type brake caliper assembly and a disc brake (7). The assembly comprises a support and sliding bracket (1) for a caliper body (3), which comprises a first side element (4) facing a first braking surface (6) of a disc brake (7) by means of a first brake pad (5). The caliper body (3) also comprises a second side element (9) facing a second braking surface (11) of the disc brake (7) by means of a second brake pad (10). A bridge element (12) connects the first and second side elements (4, 9). The caliper body (3) comprises axial sliding seats (13, 14) to allow axial movement when the brake pads (5, 10) are actuated. The assembly also comprises a stub axle (25) with fixing portions for the bracket (1), using end portions shaped as spherical cap portions (35) and stud bolt drive heads (36) shaped as spherical cap portions (37), corresponding so as to ensure precise alignment and to reduce deformation during braking.

### FIELD OF THE INVENTION

The subject of the present invention is a support and sliding bracket and stub axle assembly for a floating type caliper body, as well as a floating type brake caliper and a disc brake.

In the following, the disc brake assembly will be described with reference to the rotation axis of the disc, indicated by the reference X-X, which defines an axial direction A-A. By axial direction, it is meant any direction A-A directed parallel to the rotation axis X-X of the disc brake. Furthermore, by radial direction R-R, it is meant a direction orthogonal to the rotation axis X-X and incident therewith. Still further, by circumferential direction C-C, it is meant that circumference orthogonal to the axial direction A-A and to the radial directions R-R. Conversely, by tangential direction T-T, it is meant a direction which at each point is orthogonal to an axial direction A-A and a radial direction R-R and tangent to a circumferential direction C-C passing through said point.

In a disc brake, the brake caliper is arranged straddling the outer peripheral edge of a brake disc. The brake caliper usually comprises a body with portions arranged to face opposite braking surfaces of a disc. Brake pads are provided arranged between each portion of the caliper and the braking surfaces of the brake disc. At least one portion of the caliper body has actuation devices capable of exerting a thrust action on the pads by abutting them against the braking surfaces of the disc in order to exert a braking action on the vehicle.

The brake calipers, in this case their support brackets, are usually constrained to a support structure that remains fixed to the vehicle, such as for example a hub connected to a stub axle of a vehicle suspension.

In a typical arrangement, the support bracket has two or more connection portions of the caliper to the hub, for example providing slots or eyelets, for example arranged axially or radially, or through holes, suitable for receiving stud bolts for securing the caliper, which with their ends are housed in threaded holes provided on the caliper support.

In a typical construction of a caliper body, the portions of the caliper body arranged facing the braking surfaces of the disc are connected to one another by at least one bridge element placed straddling the disc.

In particular, a floating-type disc brake assembly comprises a brake caliper, also referred to as caliper body, floatably connected to a support, sometimes referred to as bracket or support bracket. The brake caliper is configured to be arranged straddling a brake disc and to urge brake pads along said axial direction A-A in approach to said brake disc from at least one actuation device from a rest position of the pad to a braking position of the pad.

Said caliper body comprises a first side element suitable for facing, by means of a first brake pad, a first braking surface of a brake disc.

Said first side element houses at least one thrust element suitable for urging said first brake pad against said first braking surface in order to exert a braking action on a vehicle.

Said caliper assembly further comprises a second side element suitable for facing, by means of a second brake pad, a second braking surface of said brake disc.

At least one bridge-like element is suitable for being placed straddling the brake disc connecting said first side element to said second side element.

Said caliper body comprises a first axial sliding seat suitable for allowing said caliper body to slide axially when said at least one thrust element urges said first pad.

Said caliper body comprises a second axial sliding seat suitable for allowing said caliper body to slide axially when said at least one thrust element urges said first pad.

As is known, floating caliper assemblies, thus having pad thrust elements only on their side facing the disc, are known for reducing the construction complexity of brake calipers intended for vehicles and motorcycles.

The caliper comprises various components mounted on the body such as pistons, seals, bleed devices, and brake fluid supply ducts.

Typically, the caliper body is made of metal such as aluminium, or aluminium alloy or cast iron. The caliper body can be obtained by casting, but also by chip removal machining, as well as by forging.

The caliper body can be made either as a single-piece or in a single piece or enbloc, but also in two half-calipers typically connected to one another along a plane which usually coincides with the median plane of the disc over which the caliper is placed straddling.

In the case where the driver of the vehicle wishes to brake or slow down the motion of the vehicle, he applies a force on the brake pedal, in the case of a motor vehicle. This force on the brake pedal, via a brake master cylinder, generates a brake fluid pressure which through a duct is applied to the brake fluid present in the hydraulic circuit inside the caliper body up to the cylinders where the pressure is exerted on the bottom surface of the pistons, forcing them to press against the pads, which in turn abut against the braking surfaces of the disc.

The pressure action of the brake fluid is also exerted on the bottom wall of the cylinder, causing a reaction in the caliper body which deforms it by moving away from the surfaces of the disc. This deformation of the caliper body leads to an increase in the stroke of the pistons and thus to an increase in the stroke of the brake pedal.

The caliper body also deforms as a function of the torque exerted by the action of the pistons which, by abutting the pads against the braking surfaces of the disc. apply, in directions forming torque arms with respect to the fixing points of the caliper body to its support, a deformation moment. These torques deform the caliper body also in a tangential and radial direction with respect to the disc, as well as axially.

The caliper body must therefore have sufficient structural stiffness so as to ensure that this deformation of the caliper body caused by the braking action is kept within tolerable values, which, in addition to avoiding damage to the braking system, do not create for the driver the sensation of a yielding braking system, determining an extra stroke of the brake lever or pedal, creating a sensation of a system referred to by sports car drivers as “spongy”. This need leads to extremely stiff structures for caliper bodies and therefore to an increase in their bulk and weight.

On the other hand, the caliper body being constrained to the vehicle suspension and arranged straddling the disc, constitutes one of the unsprung masses that is desired to be reduced as much as possible in order to increase the vehicle's performance.

Obviously, these considerations are taken to the extreme when the vehicle is of the racing type and the user wishes to have a braking system extremely responsive to his commands and at the same time extremely light so as not to penalise the performance of the racing vehicle.

Therefore, there is a felt need for a disc brake caliper body having improved structural characteristics at the same weight of the caliper body, or at equal structural characteristics a lower weight compared to known solutions.

### PRIOR ART

Braking systems for vehicles comprise various components designed to slow down or stop the movement of the vehicle. Among these components, floating calipers play a crucial role in transferring the braking force to the brake discs. Floating calipers are mounted on brackets that connect the caliper to the wheel hub, ensuring the stability and effectiveness of the braking system. These brackets must be designed to withstand high mechanical stresses, while maintaining a reduced weight to improve the overall efficiency of the vehicle.

In braking systems, one of the main objectives is to reduce the weight of the components without compromising the stiffness and reliability of the system. A reduced weight helps improve fuel efficiency and vehicle performance. Furthermore, a simplified geometry of the components facilitates assembly and maintenance, reducing production costs and improving integration with other components of the braking system.

Another objective is to ensure a precise alignment of the components during assembly. Accurate alignment is essential for the correct functioning of the braking system, as it reduces irregular wear of the components and improves the braking feel for the driver. The ability to compensate for any deformation during the braking action is fundamental to maintain the effectiveness of the system over time.

Reducing bulk is a further objective, as the space available in the wheel is limited. A compact design of the brackets for floating calipers allows to optimise the use of space, improving integration with other vehicle components and reducing the risk of interference.

Currently, the support and sliding brackets of floating calipers have the bracket-to-hub fixing area very distant from the pad thrust point on the bracket. As a result, for structural requirements, the brackets of floating calipers include a crossbar connecting the fixing ears. This connecting crossbar entails some main issues: complexity of the shape of implementation of the bracket due to its difficult coexistence with the rest of the components, and an increase in weight.

The document EP2959178B1 describes a solution of floating caliper body and standard bracket with two bridge elements or crossbars, inner and outer side. However, this document aims to increase the contact area between the bolt or tie rod connecting the caliper to the stub axle in order to ensure greater monolithic stiffness without relative movements between caliper and stub axle. This solution is complex to construct because it requires the formation of undercuts in the bracket and in the stub axle to allow the insertion and coupling of the components with one another, so as to render these components perfectly integral with one another.

The document WO2021215157 describes a solution of floating caliper body and standard bracket with two bridge elements or crossbars, inner and outer side. This document discloses the possibility of connecting the bracket to the hub either in axial or radial direction. Similar solutions are known from EP3032125, U.S. Pat. Nos. 9,222,532, 9,447,829 and US20080135352. The document JP3882138 shows an axial and radial connection. The document JP2009287720 shows a circumferential and axial connection or two circumferential connections.

The document JP2010091022 describes a solution of floating caliper body and standard bracket with two bridge elements or crossbars, inner and outer side.

The document EP3492770 describes a solution of floating caliper body and bracket without the inner bridge element. However, this solution requires the connection points to the hub to be provided in bulky areas, thus obliging the bracket to have even greater bulk in radial and circumferential direction.

The document DE102014113521 describes a solution of floating caliper body and bracket without the outer bridge element. This solution proves incompatible with requirements for high-performance stiffness of the brake caliper and, if subjected to high stresses, may result in deformability, giving the vehicle driver a non-immediate braking feeling (sensation referred to in English as “spongy”).

There is therefore the need for a solution that reduces the bulk of the components due to the need for availability of space in the wheel, without sacrificing stiffness.

### SOLUTION

These and other objects are achieved by a support and sliding bracket and stub axle assembly according to claim 1, as well as a brake caliper assembly according to claim 12 and a disc brake according to claim 13.

Some advantageous embodiments are the subject of the dependent claims.

According to a general embodiment, the assembly uses seats shaped as spherical cap portions and fixing stud bolts with heads shaped as spherical cap portions. This design ensures a precise alignment between stub axle and bracket during assembly and thus reduces the deformation of the bracket before and during braking. The spherical cap shapes allow better coupling and compensate for misalignments caused by tolerances and deformations, leading to a more accurate and higher-performance assembly and thus allowing a reduction in the dimensions and therefore in the mass of the bracket.

From the analysis of this solution, it has emerged that the proposed solution allows several aspects to be optimised.

Thanks to the proposed solutions, numerous advantages can be achieved.

A fundamental improvement is obtained through the use of stud bolts with control head shaped as a spherical cap portion. These bolts, housed in seats shaped as spherical cap portions, improve alignment and compensate for any deformations of the support and sliding bracket during assembly. Therefore, one of the main advantages of this solution is improved alignment during assembly. The problem of precise alignment of the parts during assembly is solved thanks to the ideal contact along a circumference between the control head shaped as a spherical cap of larger diameter than the spherical cap-shaped seat, reducing the contact area and facilitating alignment and backlash recovery during assembly.

Furthermore, the reduction of bulk and weight represents the main objective in the context of support and sliding brackets used in floating brake caliper assemblies, while maintaining the necessary stiffness of the assembly. A significant advantage of this innovation is the reduction of the weight of the support and sliding bracket. The problem of overweight brackets, caused by the need for bulky bracket bridge elements or crossbars sometimes connected by an inner crossbar, is solved thanks to the provision of a coupling to

the stud bolt that allows compensation of misalignments.

Consequently, it is also possible, according to variant embodiments, to eliminate the crossbar connecting the bridge elements or crossbars of the support and sliding bracket. This is also possible thanks to the new positioning of the fixing area near the thrust point of the brake pad, thus allowing a lighter and more compact design.

In some solutions, the elimination of the inner crossbar optimises the performance/weight ratio and simplifies the geometry of the support and sliding bracket. The proposed configuration aims to optimise the ratio between performance and weight of the support and sliding bracket. The new geometrical configuration simplifies the structure of the support and sliding bracket, facilitating assembly and improving efficiency. This leads to an improvement in the performance/weight ratio, solving the problem of inefficiency in the ratio between the performance of the support and sliding bracket and its weight. The absence of the crossbar and the use of stud bolts with control head shaped as a spherical cap portion optimise load transfer and stiffness, improving overall efficiency.

The simplification of the geometry of the support and sliding bracket solves the design complexity that makes integration with other components difficult. The new design eliminates the need for an inner crossbar, making the geometry simpler and more compatible with the rest of the components. The reduction of bulk is a further advantage, solving the problem of the limited space available in the wheel for the installation of the support and sliding bracket. The compact design without inner crossbar and with optimised fixing area allows bulk to be reduced without compromising functionality.

The positioning of the fixing area near the thrust point of the brake pad improves load distribution and structural stiffness. The distance between the axis of the guide seat and the axis of the hub connection seat, between 1 and 2 times the diameter of the hub connection seat, contributes to structural optimisation and to a correct transfer of the load to the hub, limiting the deformation of the support and sliding bracket and allowing its mass and bulk to be reduced. This leads to greater stiffness of the support and sliding bracket, solving the problem of deformability under high stresses, which may negatively affect braking feel. The reduced distance between the fixing points and the point of application of the force, together with the use of stud bolts with control head shaped as a spherical cap portion, improves structural stiffness.

In summary, the proposed configuration aims to optimise the ratio between performance and weight of the support and sliding bracket, simplifying the geometry of the support and sliding bracket, facilitating assembly and improving overall efficiency. dr

### FIGURES

Further features and advantages of the invention will appear from the following description of preferred embodiments thereof, given by way of non-limiting example, with reference to the accompanying figures in which:

FIG. 1 shows, in exploded axonometric view, a floating caliper and disc brake assembly according to the prior art;

FIG. 2 illustrates, in axonometric view, a further example of floating caliper according to the prior art;

FIG. 3 shows, in axonometric view, a disc brake with floating caliper connected to a stub axle wherein the connection takes place with a stub axle having a through seat and bracket with threaded seat and control head of a stud bolt received in end portion of the stub axle seat, in this embodiment the axis of the stub axle seat is directed according to an axial direction;

FIG. 4 illustrates, in front view on the vehicle side, the disc brake of FIG. 3;

FIG. 5 shows, in side sectional view along a plane containing an axial and radial direction at the first bracket seat axis, the disc brake of FIG. 3;

FIG. 6 illustrates, in axonometric view, an exploded detail of a bracket, stub axle and stud bolts assembly of the assembly of FIG. 3;

FIG. 7 shows the assembly of FIG. 6 in section along a plane containing an axial and radial direction passing through the bracket seat axis;

FIG. 8 illustrates the assembly of FIG. 6 in section along a plane containing an axial and radial direction passing through the bracket seat axis, but with the components assembled together;

FIG. 9 shows, in axonometric view, a disc brake with floating caliper connected to a stub axle wherein the connection takes place with bracket with through seat and stub axle having threaded seat, wherein the control head of the stud bolt is received in end portion of the bracket seat, in this embodiment the axis of the stub axle seat is directed according to an axial direction;

FIG. 10 Illustrates, in Front View on the Vehicle Side, the Disc Brake of FIG. 9;

FIG. 11 shows, in side sectional view along a plane containing an axial and radial direction at the first bracket seat axis, the disc brake of FIG. 9;

FIG. 12 illustrates, in axonometric view, an exploded detail of a bracket, stub axle and stud bolts assembly of the assembly of FIG. 9;

FIG. 13 shows, in axonometric view, a disc brake with floating caliper connected to a stub axle wherein the connection takes place with bracket with through seat and stub axle having threaded seat, wherein the control head of the stud bolt is received in end portion of the bracket seat, in this embodiment the axis of the stub axle seat is directed according to a radial direction;

FIG. 14 illustrates, in front view on the vehicle side, the disc brake of FIG. 13;

FIG. 15 shows, in side sectional view along a plane containing an axial and radial direction at the first bracket seat axis, the disc brake of FIG. 13;

FIG. 16 illustrates, in axonometric view, an exploded detail of a bracket, stub axle and stud bolts assembly of the assembly of FIG. 13;

FIG. 17 shows, in front view on the vehicle side, a detail of a disc brake with brake caliper assembly, bracket and stub axle in which the fixing seat of the stub axle is partially overlapped to the pad support surface along a circumferential direction and the extension direction of the stub axle fixing seat is parallel to an axial direction;

FIG. 18 shows, in front view on the vehicle side, a detail of a disc brake with brake caliper assembly, bracket and stub axle in which the fixing seat of the stub axle is partially overlapped to the pad support surface along a circumferential direction and the extension direction of the stub axle fixing seat is parallel to a radial direction.

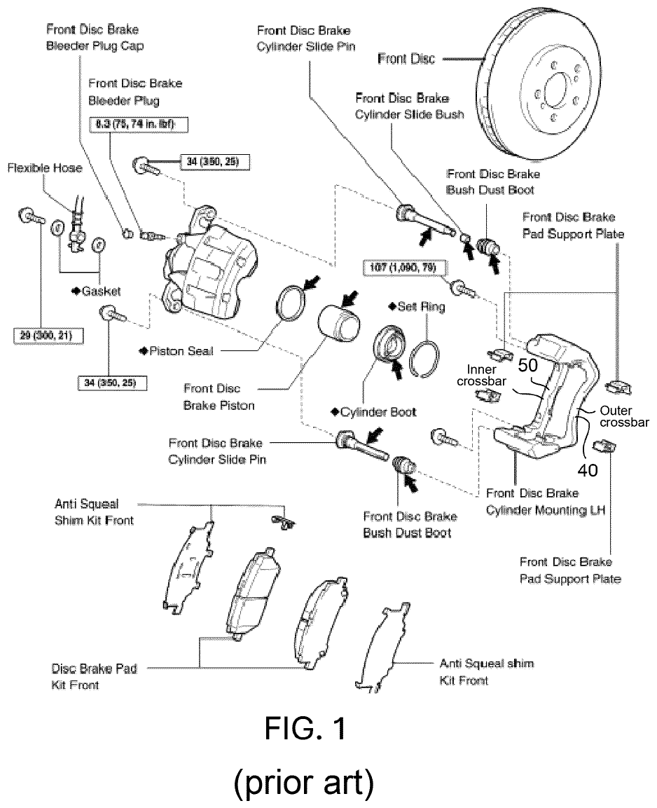

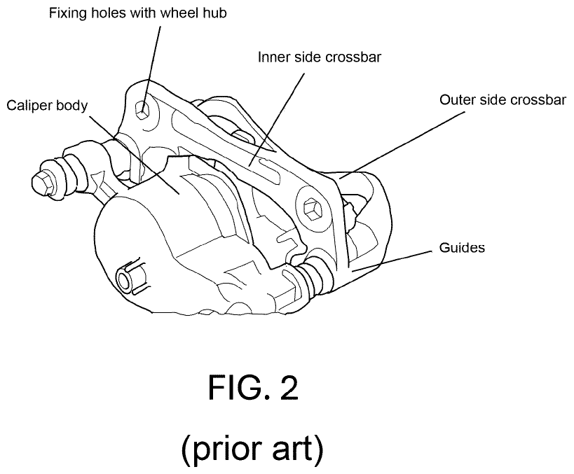

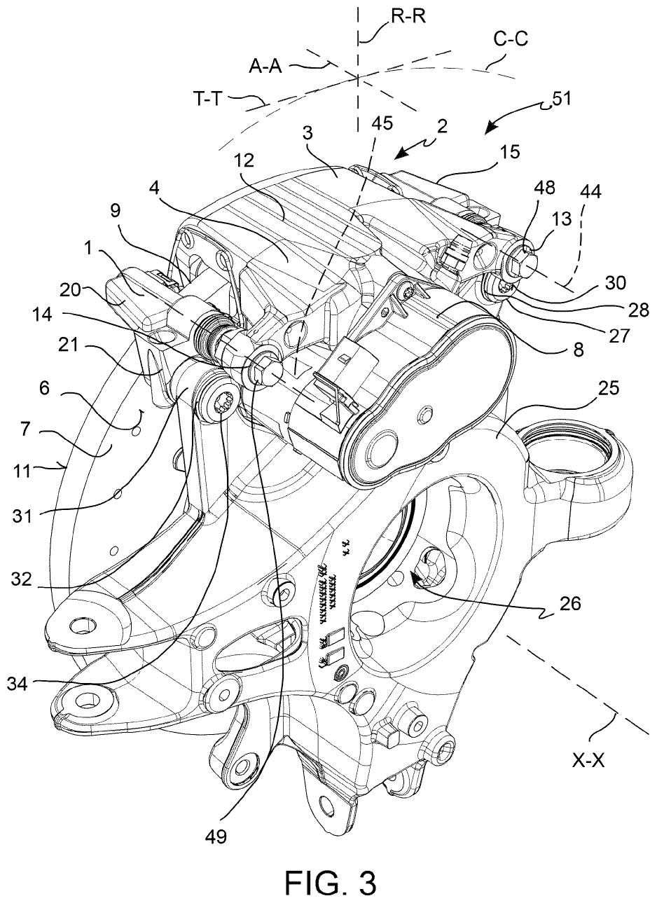

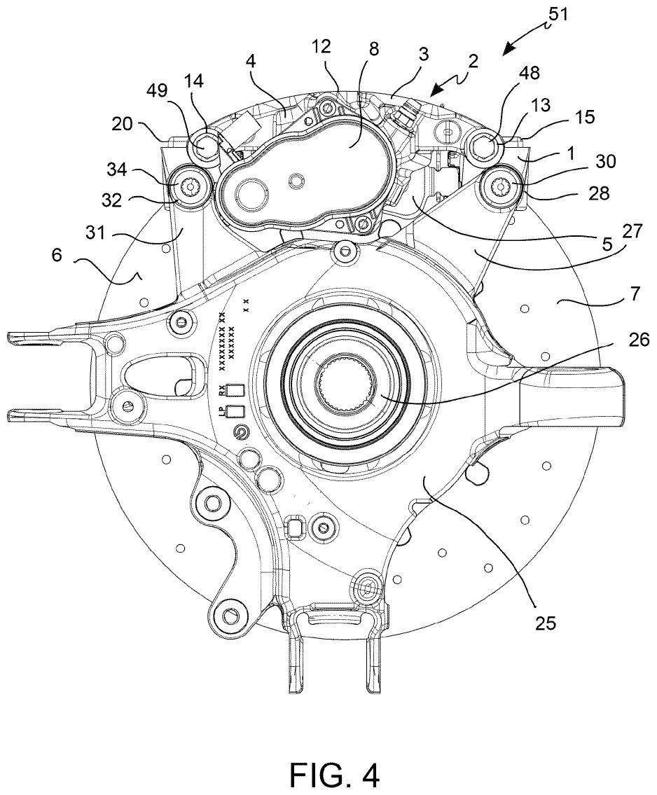

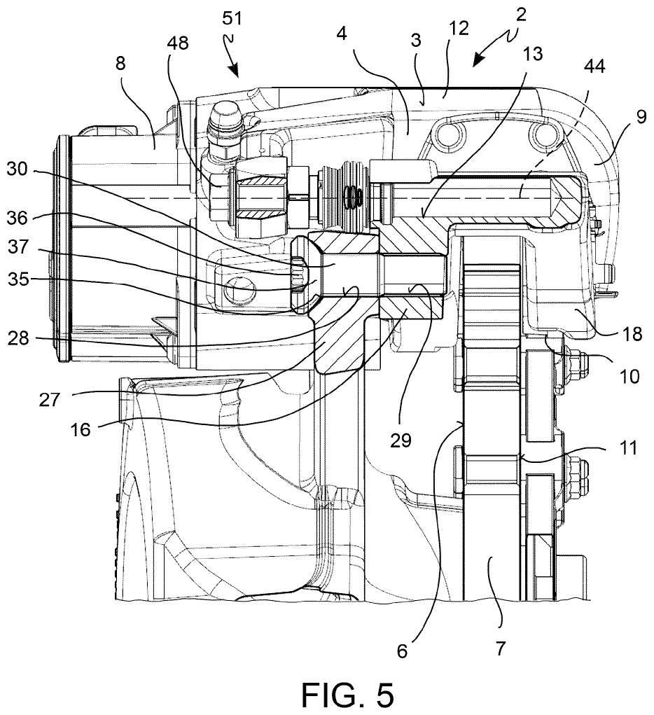

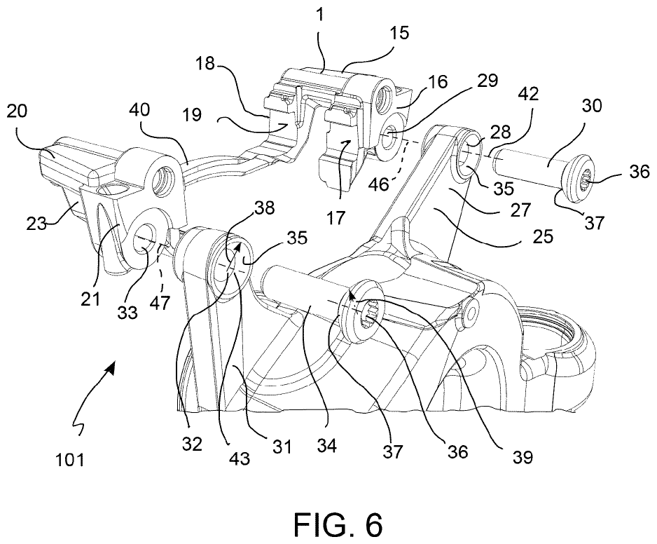

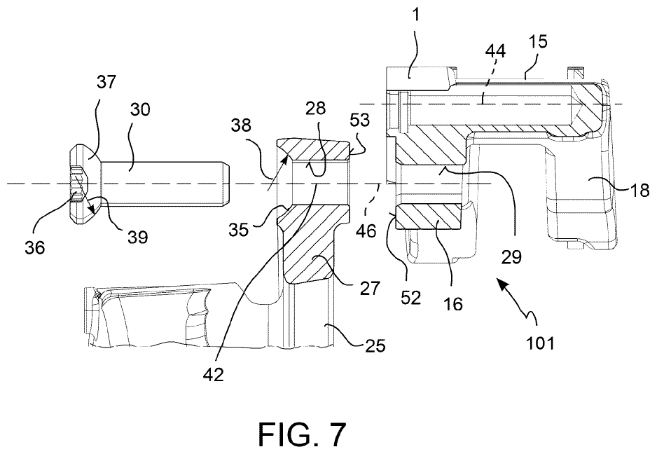

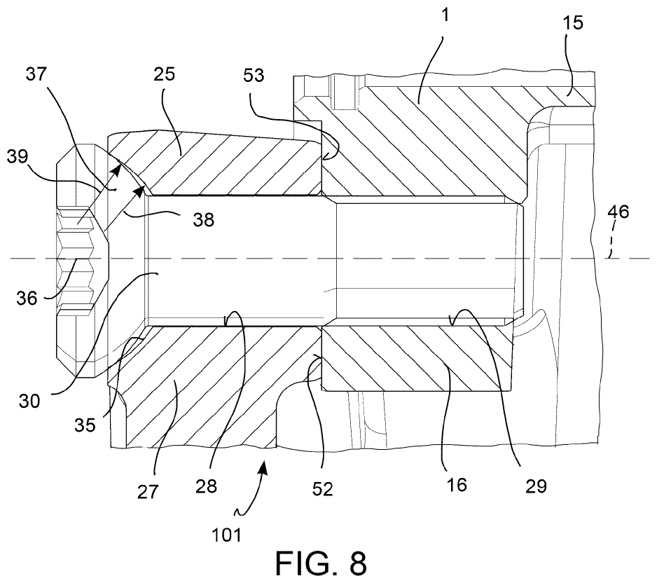

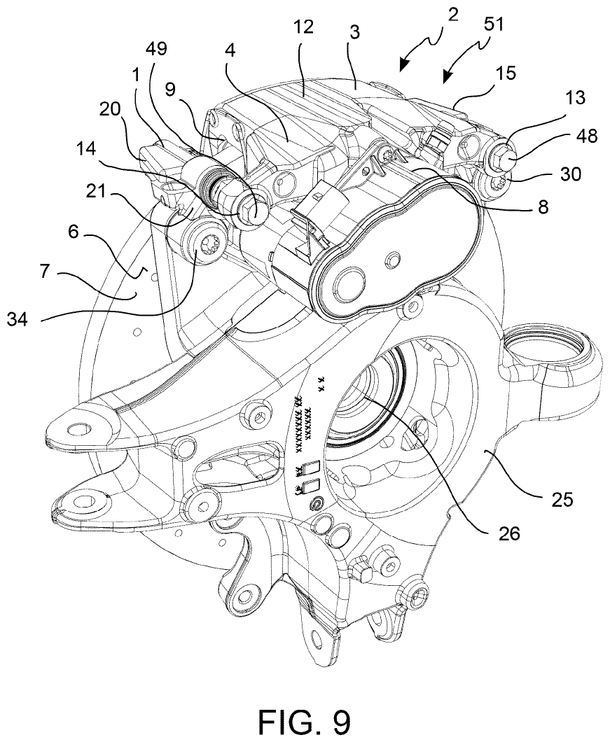

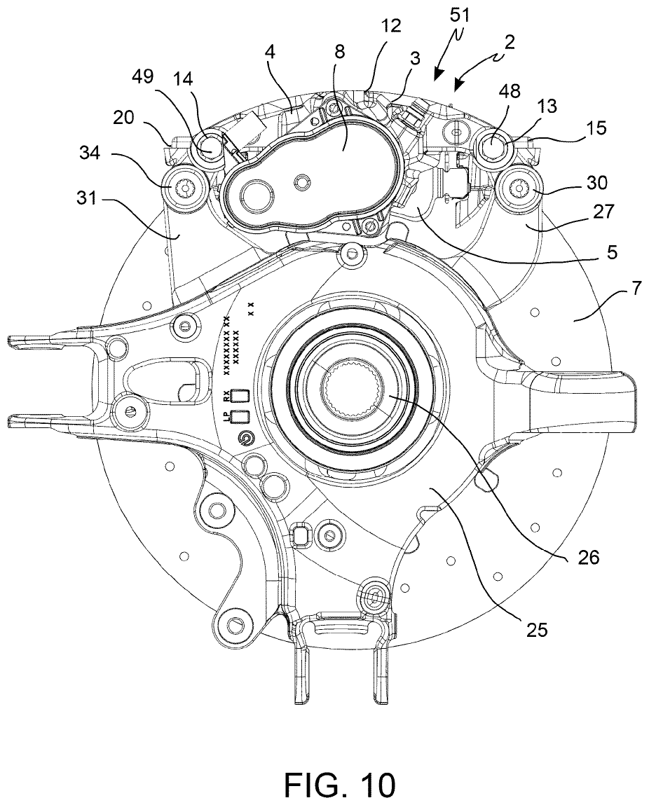

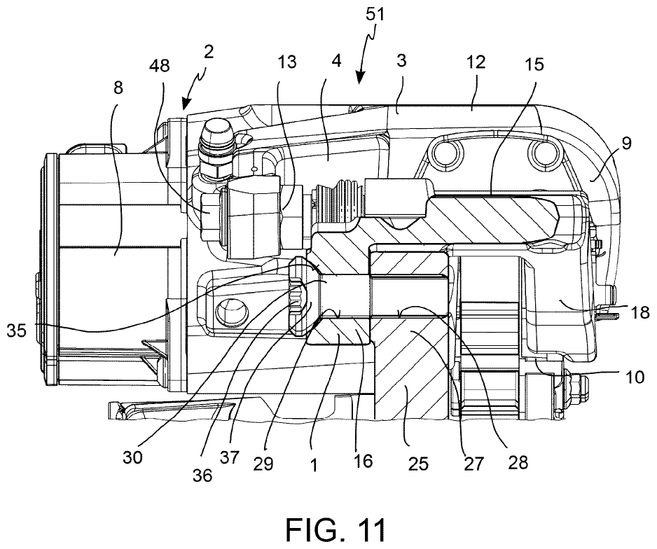

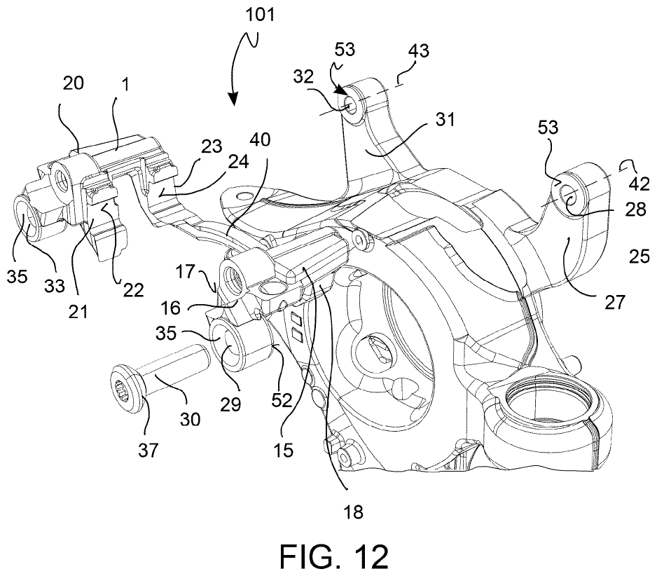

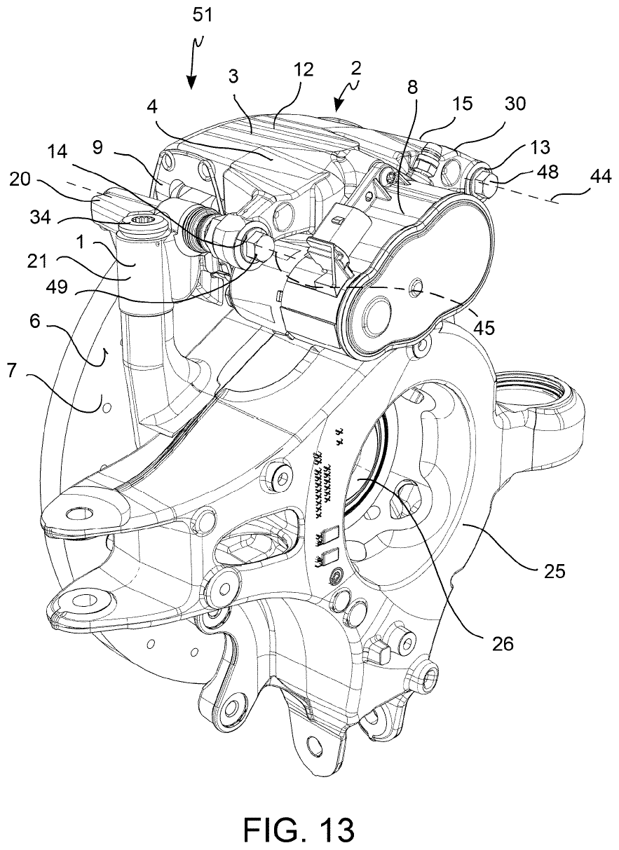

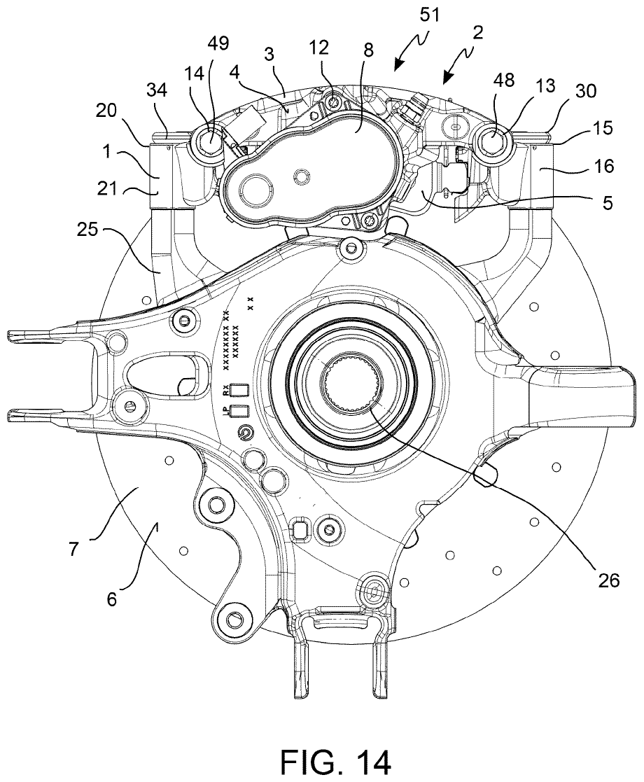

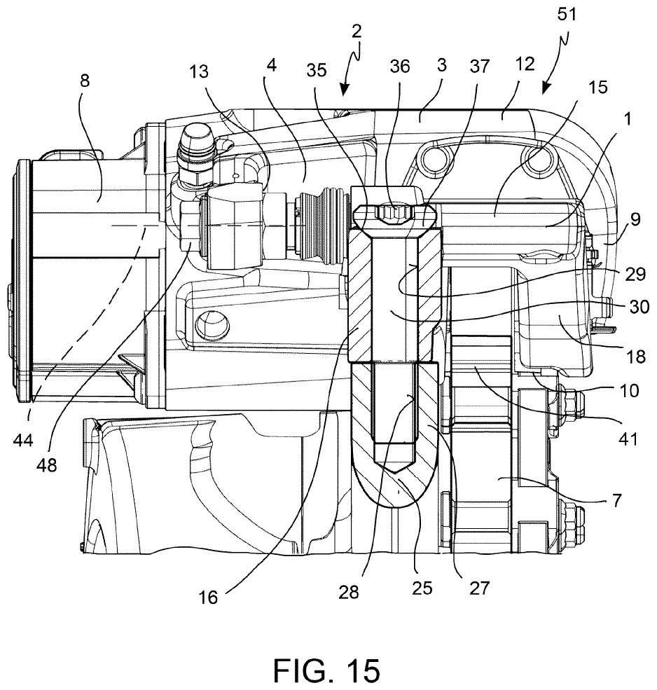

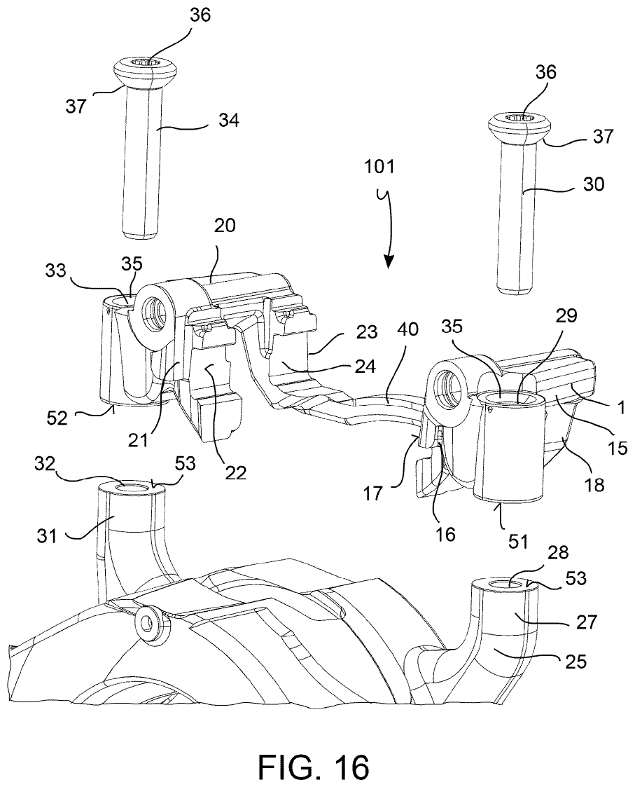

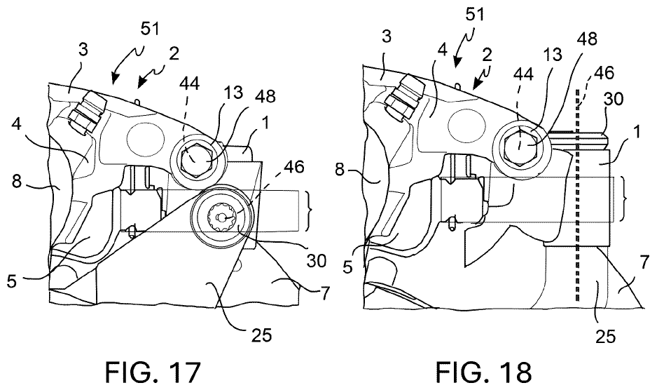

### DESCRIPTION OF SOME PREFERRED EMBODIMENTS

According to a general embodiment, the support and sliding bracket and stub axle assembly 101 comprises at least one support and sliding bracket 1 for a caliper body 3.

The caliper body 3 comprises a first side element 4 suitable for facing, by means of a first brake pad 5, a first braking surface 6 of a brake disc 7.

The brake disc 7 defines an axial direction A-A directed according to, or parallel to, a rotation axis X-X of said brake disc 7; a radial direction R-R orthogonal to said axial direction A-A and directed radially to said rotation axis X-X; a circumferential direction C-C running along a circumference and directed, at each intersection point between an axial direction A-A and a radial direction R-R, simultaneously orthogonally to said axial direction A-A and said radial direction R-R.

The first side element 4 houses at least one thrust element 8 suitable for urging the first brake pad 5 against the first braking surface 6 to apply a braking action to a vehicle.

The caliper body 3 further comprises a second side element 9 suitable for facing, by means of a second brake pad 10, a second braking surface 11 of said brake disc 7.

The caliper body 3 further comprises at least one bridge-like element 12 suitable for being placed straddling the brake disc 7 connecting the first side element 4 to the second side element 9.

The caliper body 3 comprises at least a first axial sliding seat 13 adapted to accommodate a first sliding guide 48 to slide the caliper body 4 axially when the thrust element 8 urges the first pad 5.

The support and sliding bracket 1 comprises at least a first bracket bridge-like element 15 suitable for being placed straddling the brake disc 7.

The first bracket bridge-like element 15 comprises a first connection element 16 which forms at least a first pad support surface 17 adapted to receive the support of the first brake pad 5 when abutting against the first braking surface 6 of said brake disc 7.

The first bracket bridge-like element 15 comprises a second connection element 18 which forms at least a second pad support surface 19 adapted to receive the support of the second brake pad 10 when abutting against the second braking surface 11 of said brake disc 7.

The support and sliding bracket and stub axle assembly 101 comprises a stub axle 25 adapted to connect to a wheel hub 26.

The stub axle comprises at least a first stub axle fixing portion 27 for the support and sliding bracket 1.

The first stub axle fixing portion 27 comprises a first stub axle fixing seat 28.

The first connection element 16 of the support and sliding bracket 1 comprises a first bracket fixing seat 29.

The support and sliding bracket and stub axle assembly 101 comprises at least a first stud bolt 30.

Said first stud bolt 30 comprises a stud control head 36.

Advantageously, either the first stub axle fixing seat 28 or the first bracket fixing seat 29 is through-hole and the other is threaded to connect the support and sliding bracket 1 to the stub axle 25 by means of the first stud bolt 30.

Either the first stub axle fixing seat 28 or the first bracket fixing seat 29 comprises an end portion shaped as a spherical cap portion 35 facing the stud control head 36.

The stud control head 36 comprises a stud head portion shaped as a spherical cap portion 37 and is adapted to be inserted into the end portion shaped as a spherical cap portion 35.

A first embodiment of the invention is described in detail below. The support and sliding bracket 1 serves as the main support structure for the caliper body 3. The support and sliding bracket 1 includes various elements designed to ensure the correct alignment and functionality of the braking system. The support and sliding bracket 1 is configured to be mounted on the stub axle 25 and provides the necessary support for the caliper body 3 to function effectively.

The brake caliper assembly 2 comprises the caliper body 3 and the support and sliding bracket 1. The brake caliper assembly 2 is designed to be mounted on the stub axle 25, ensuring proper alignment and functionality of the braking system. The brake caliper assembly 2 includes various components that work together to provide effective braking performance.

The caliper body 3 is a component of the braking system that houses the elements necessary for the braking action. The caliper body 3 includes the first side element 4 and the second side element 9, which are positioned on opposite sides of the brake disc 7. The caliper body 3 also includes the bridge-like element 12, which connects the first side element 4 and the second side element 9, allowing the caliper body 3 to be positioned straddling the brake disc 7.

The first side element 4 is designed to face the first braking surface 6 of the brake disc 7. The first side element 4 houses the thrust element 8, which applies pressure to the first brake pad 5, pressing the first brake pad 5 against the first braking surface 6 to generate the braking action. The first side element 4 is also provided with the first axial sliding seat 13, which accommodates the first sliding guide 48, allowing the caliper body 3 to move axially when the thrust element 8 is activated.

The first brake pad 5 is positioned between the first side element 4 and the first braking surface 6 of the brake disc 7. The first brake pad 5 is pressed against the first braking surface 6 by the thrust element 8, creating the necessary friction for braking.

The first braking surface 6 is the surface of the brake disc 7 that comes into contact with the first brake pad 5. The first braking surface 6 is designed to withstand the friction and heat generated during braking.

The brake disc 7 is the rotating component of the braking system over which the caliper body 3 is positioned. The brake disc 7 defines the axial direction A-A, which is parallel to the rotation axis X-X of the brake disc 7. The brake disc 7 also defines the radial direction R-R, which is orthogonal to the axial direction A-A, and the circumferential direction C-C, which is orthogonal to both the axial direction A-A and the radial direction R-R.

The thrust element 8 is housed inside the first side element 4 and is responsible for applying pressure to the first brake pad 5. The thrust element 8 is, for example, activated by hydraulic pressure or by the thrust of a component set in roto-translation by an electric motor as shown in the figures, which forces the first brake pad 5 against the first braking surface 6, generating the braking action.

The second side element 9 is positioned on the opposite side of the brake disc 7 with respect to the first side element 4. The second side element 9 faces the second braking surface 11 of the brake disc 7 and houses the second brake pad 10. The second side element 9 is connected to the first side element 4 by the bridge-like element 12.

The second brake pad 10 is positioned between the second side element 9 and the second braking surface 11 of the brake disc 7. The second brake pad 10 is pressed, by the translation of the caliper body 3, against the second braking surface 11 during braking, generating the necessary friction to stop the vehicle.

The second braking surface 11 is the surface of the brake disc 7 that comes into contact with the second brake pad 10. The second braking surface 11 is designed to withstand the friction and heat generated during braking.

The bridge-like element 12 connects the first side element 4 and the second side element 9, allowing the caliper body 3 to be positioned straddling the brake disc 7. The bridge-like element 12 provides structural integrity to the caliper body 3 and ensures that the braking force is evenly distributed over the brake disc 7.

The first axial sliding seat 13 is located inside the first side element 4 and accommodates the first sliding guide 48. The first axial sliding seat 13 allows the caliper body 3 to move axially when the thrust element 8 is activated, ensuring that the first brake pad 5 is pressed evenly against the first braking surface 6.

The second axial sliding seat 14 is located inside the second side element 9 and accommodates the second sliding guide 49. The second axial sliding seat 14 allows the caliper body 3 to move axially when the thrust element 8 is activated, ensuring that the second brake pad 10 is pressed evenly against the second braking surface 11.

The first bracket bridge-like element 15 is part of the support and sliding bracket 1 and is designed to be positioned straddling the brake disc 7. The first bracket bridge-like element 15 includes the first connection element 16 and the second connection element 18, which respectively provide support for the first brake pad 5 and the second brake pad 10.

The first connection element 16 forms the first pad support surface 17, which supports the first brake pad 5 when the first brake pad 5 is pressed against the first braking surface 6. The first connection element 16 ensures that the first brake pad 5 is correctly aligned and supported during braking.

The first pad support surface 17 is the surface on the first connection element 16 that supports the first brake pad 5. The first pad support surface 17 ensures that the first brake pad 5 is correctly aligned and supported during braking.

The second connection element 18 forms the second pad support surface 19, which supports the second brake pad 10 when the second brake pad 10 is pressed against the second braking surface 11. The second connection element 18 ensures that the second brake pad 10 is correctly aligned and supported during braking.

The second pad support surface 19 is the surface on the second connection element 18 that supports the second brake pad 10. The second pad support surface 19 ensures that the second brake pad 10 is correctly aligned and supported during braking.

The second bracket bridge-like element 20 is part of the support and sliding bracket 1 and is designed to be positioned straddling the brake disc 7. The second bracket bridge-like element 20 includes the third connection element 21 and the fourth connection element 23, which respectively provide support for the first brake pad 5 and the second brake pad 10.

The third connection element 21 forms the third pad support surface 22, which supports the first brake pad 5 when the first brake pad 5 is pressed against the first braking surface 6. The third connection element 21 ensures that the first brake pad 5 is correctly aligned and supported during braking.

The third pad support surface 22 is the surface on the third connection element 21 that supports the first brake pad 5. The third pad support surface 22 ensures that the first brake pad 5 is correctly aligned and supported during braking.

The fourth connection element 23 forms the fourth pad support surface 24, which supports the second brake pad 10 when the second brake pad 10 is pressed against the second braking surface 11. The fourth connection element 23 ensures that the second brake pad 10 is correctly aligned and supported during braking.

The fourth pad support surface 24 is the surface on the fourth connection element 23 that supports the second brake pad 10. The fourth pad support surface 24 ensures that the second brake pad 10 is correctly aligned and supported during braking.

The stub axle 25 is a component that connects the support and sliding bracket 1 to the wheel hub 26. The stub axle 25 includes various portions and seats designed to ensure proper alignment and functionality of the braking system.

The wheel hub 26 is the component that connects the stub axle 25 to the vehicle wheel. The wheel hub 26 ensures that the braking system is correctly aligned and supported.

The first stub axle fixing portion 27 is a part of the stub axle 25 that connects to the support and sliding bracket 1. The first stub axle fixing portion 27 includes the first stub axle fixing seat 28, which accommodates the first stud bolt 30.

The first stub axle fixing seat 28 is a seat on the first stub axle fixing portion 27 that accommodates the first stud bolt 30. The first stub axle fixing seat 28 ensures that the support and sliding bracket 1 is correctly aligned and fixed to the stub axle 25.

The first bracket fixing seat 29 is a seat on the first connection element 16 of the support and sliding bracket 1 that accommodates the first stud bolt 30. The first bracket fixing seat 29 ensures that the support and sliding bracket 1 is correctly aligned and fixed to the stub axle 25.

The first stud bolt 30 is a fastening element that connects the support and sliding bracket 1 to the stub axle 25. The first stud bolt 30 includes a stud control head 36, designed to ensure correct alignment and fixing.

The stud control head 36 is the head of the first stud bolt 30. The stud control head 36 includes a stud head portion shaped as a spherical cap portion 37, designed to be inserted into the end portion shaped as a spherical cap portion 35 on the first stub axle fixing seat 28 or on the first bracket fixing seat 29.

The end portion shaped as a spherical cap portion 35 is a spherical

sector-shaped portion on the first stub axle fixing seat 28 or on the first bracket fixing seat 29. The end portion shaped as a spherical cap portion 35 ensures proper alignment and fixing of the first stud bolt 30.

The stud head portion shaped as a spherical cap portion 37 is a spherical sector-shaped portion on the stud control head 36. The stud head portion shaped as a spherical cap portion 37 is inserted into the end portion shaped as a spherical cap portion 35, ensuring correct alignment and fixing of the first stud bolt 30.

The second stub axle fixing portion 31 is a part of the stub axle 25 that connects to the support and sliding bracket 1. The second stub axle fixing portion 31 includes the second stub axle fixing seat 32, which accommodates the second stud bolt 34.

The second stub axle fixing seat 32 is a seat on the second stub axle fixing portion 31 that accommodates the second stud bolt 34. The second stub axle fixing seat 32 ensures that the support and sliding bracket 1 is correctly aligned and fixed to the stub axle 25.

The second bracket fixing seat 33 is a seat on the third connection element 21 of the support and sliding bracket 1 that accommodates the second stud bolt 34. The second bracket fixing seat 33 ensures that the support and sliding bracket 1 is correctly aligned and fixed to the stub axle 25.

The second stud bolt 34 is a fastening element that connects the support and sliding bracket 1 to the stub axle 25. The second stud bolt 34 includes a stud control head 36, designed to ensure correct alignment and fixing.

According to one embodiment, the knurled elements 41 are knurled elements interposed between the support and sliding bracket 1 and the stub axle 25. The knurled elements 41 reduce the tightening force required for the first stud bolt 30 and the second stud bolt 34, allowing the use of smaller fastening elements and further reducing the overall mass of the support and sliding bracket and stub axle assembly 101.

According to one embodiment, the first stub axle seat axis flat and the second stub axle seat axis 43 are axes of the seats on the stub axle 25 that accommodate the fastening elements. These axes ensure correct alignment and fixing of the support and sliding bracket 1 to the stub axle 25.

According to one embodiment, the first guide seat axis 44 and the second guide seat axis 45 are axes of the seats on the caliper body 3 that accommodate the guides. These axes ensure correct alignment and fixing of the guides to the caliper body 3.

The first bracket seat axis 46 and the second bracket seat axis 47 are axes of the seats on the support and sliding bracket 1 that accommodate the fastening elements. These axes ensure correct alignment and fixing of the support and sliding bracket 1 to the stub axle 25.

The first sliding guide 48 is a guide inserted into the first axial sliding seat 13 on the first side element 4. The first sliding guide 48 allows the caliper body 3 to move axially when the thrust element 8 is activated.

The second sliding guide 49 is a guide inserted into the second axial sliding seat 14 on the second side element 9. The second sliding guide 49 allows the caliper body 3 to move axially when the thrust element 8 is activated.

The disc brake 51 is the overall disc braking system which includes the brake caliper assembly 2 and the brake disc 7. The disc brake 51 provides the braking force necessary to stop the vehicle.

The bracket support surface 52 is a flat surface on the support and sliding bracket 1 that provides support and alignment for the stub axle 25. The bracket support surface 52 ensures that the support and sliding bracket 1 is correctly aligned and supported.

The stub axle support surface 53 is a flat surface on the stub axle 25 that provides support and alignment for the support and sliding bracket 1. The stub axle support surface 53 ensures that the stub axle 25 is correctly aligned and supported.

The outer bracket crossbar 40 is an external crossbar that connects the second connection element 18 to the fourth connection element 23. The outer bracket crossbar 40 provides stiffness to the support and sliding bracket 1 and is designed to face directly the brake disc 7 or with the second braking pad 10 interposed.

According to one embodiment, the end portion shaped as a spherical cap portion 35 is a spherical sector-shaped seat.

According to one embodiment, the stud head portion shaped as a spherical cap portion 37 is a spherical sector-shaped head portion.

According to one embodiment, the support and sliding bracket 1 comprises at least a second bracket bridge-like element 20 suitable for being placed straddling the brake disc 7.

According to one embodiment, the second bracket bridge-like element 20 comprises a third connection element 21 which forms at least a third pad support surface 22 adapted to receive the support of the first brake pad 5 when abutting against the first braking surface 6 of said brake disc 7.

According to one embodiment, the second bracket bridge-like element 20 comprises a fourth connection element 23 which forms at least a fourth pad support surface 24 adapted to receive the support of the second brake pad 10 when abutting against the second braking surface 11 of said brake disc 7.

According to one embodiment, the stub axle comprises at least a second stub axle fixing portion 31 for the support and sliding bracket 1.

According to one embodiment, the second stub axle fixing portion 31 comprises a second stub axle fixing seat 32.

According to one embodiment, the third connection element 21 of the support and sliding bracket 1 comprises a second bracket fixing seat 33.

According to one embodiment, the support and sliding bracket and stub axle assembly 101 comprises at least a second stud bolt 34.

According to one embodiment, either the second stub axle fixing seat 32 or the second bracket fixing seat 33 comprises an end portion shaped as a spherical cap portion 35 facing the first stud bolt 30.

According to one embodiment, the second stud bolt 34 comprises a stud control head 36.

According to one embodiment, the stud control head 36 comprises a stud head portion shaped as a spherical cap portion 37 and is adapted to be inserted into the end portion shaped as a spherical cap portion 35.

According to one embodiment, the first and/or second stub axle fixing seat 28 and/or 32 is a threaded seat.

According to one embodiment, the first and/or second stub axle fixing seat 28 and/or 32 is a through seat.

According to one embodiment, the first and/or second bracket fixing seat 29 and/or 33 is a through seat.

According to one embodiment, the first and/or second bracket fixing seat 29 and/or 33 is a threaded seat.

According to one embodiment, the caliper body 4 comprises at least a second axial sliding seat 14 adapted to accommodate a second sliding guide 49 to slide the caliper body 4 axially when the thrust element 8 urges the first pad 5.

According to one embodiment, the end portion shaped as a spherical cap portion 35 has a predefined seat radius 38.

According to one embodiment, the stud head portion shaped as a spherical cap portion 37 has a predefined head radius 39.

According to one embodiment, the predefined seat radius 38 is smaller than the predefined head radius 39, so that the contact between the end portion shaped as a spherical cap portion 35 and the stud head portion shaped as a spherical cap portion 37 occurs in an area limited to substantially a circumference or arc of a circumference, allowing for precise alignment during assembly and enabling better compensation of play between components, thus reducing the load on the support and sliding bracket 1, consequently reducing its dimensions, its mass and its overall encumbrance.

According to one embodiment, the support and sliding bracket 1 comprises an outer bracket crossbar 40 that connects the second connection element 18 to the fourth connection element 23 so as to stiffen the support and sliding bracket 1.

According to one embodiment, the outer bracket crossbar 40 is suitable for facing the brake disc 7 directly or with the second braking pad 10 interposed.

According to one embodiment, the support and sliding bracket 1 does not comprise any connection linking the first connection element 16 to the third connection element 21, so as to optimise the performance-to-weight ratio of the support and sliding bracket 1, reducing its weight of the support and sliding bracket 1, eliminating the issue of co-existence between the internal connection crossbar and the rest of the components within the caliper, allowing for a reduction in bulk and simplification of the geometry of the support and sliding bracket 1, and increasing its stiffness as a function of the reduction of the lever arm between the fixings and the force application point.

According to one embodiment, the first and/or second bracket fixing seat 29 and/or 33 is directed along the axial direction A-A.

According to one embodiment, the first and/or second through stub axle fixing seat 28 and/or 32 is directed along the axial direction A-A.

According to one embodiment, the first and/or second bracket fixing seat 29 and/or 33 is directed along the radial direction R-R.

According to one embodiment, the first and/or second through stub axle fixing seat 28 and/or 32 is directed along the radial direction R-R, allowing maximum mounting flexibility to the stub axle.

According to one embodiment, knurled elements 41 are interposed between the support and sliding bracket 1 and the stub axle 25, in order to allow for a reduction in the tightening load of the first and/or second stud bolt 30 and/or 34, so as to reduce the size of the bolt 30 and/or 34 and thus further reduce the mass of the assembly 101.

According to one embodiment, the first and/or second bracket fixing seat 29 and/or 33 has a first and/or second bracket seat axis 46 and/or 47.

According to one embodiment, the first and/or second axial sliding seat 13 and/or 14 has a first and/or second guide seat axis 44 and/or 45.

According to one embodiment, the distance between the first and/or second bracket seat axis 46 and/or 47 and the first and/or second guide seat axis 44 and/or 45 is less than twice the transverse dimension of the first and/or second axial sliding seat 13 and/or 14.

According to one embodiment, the first and/or second stub axle fixing seat 28 and/or 32 has a first and/or second tub axle seat axis 42 and/or 43.

According to one embodiment, the first and/or second axial sliding seat 13 and/or 14 has a first and/or second guide seat axis 44 and/or 45.

According to one embodiment, the distance between the first and/or second tub axle seat axis 42 and/or 43 and the first and/or second guide seat axis 44 and/or 45 is less than twice the transverse dimension of the first and/or second axial sliding seat 13 and/or 14.

According to one embodiment, the first and/or second bracket fixing seat 29 and/or 33 is circumferentially aligned with at least a portion of the first and/or third pad support surface 17 and/or 22.

According to one embodiment, the brake caliper assembly 2 comprises a support and sliding bracket and stub axle assembly 101 as defined in any of the previously described embodiments, as well as a floating caliper body 3, and a first and second brake pad 5, 10.

According to one embodiment, the support and sliding bracket 1 comprises at least one bracket support surface 52.

According to one embodiment, the bracket support surface 52 is a flat surface.

According to one embodiment, the stub axle 25 comprises at least one stub axle support surface 53.

According to one embodiment, the stub axle support surface 53 is a flat surface.

According to one embodiment, the stub axle 25 rests on said support and sliding bracket 1 exclusively by means of the bracket support surface 52 and the stub axle support surface 53.

According to one embodiment, the first and/or second bracket fixing seat 29 and/or 33 has a first and/or second bracket seat axis 46 and/or 47.

According to one embodiment, the first and/or second axial sliding seat 13 and/or 14 has a first and/or second guide seat axis 44 and/or 45.

According to one embodiment, the distance between the first and/or second bracket seat axis 46 and/or 47 and the first and/or second guide seat axis 44 and/or 45 is less than twice the transverse dimension of the first and/or second axial sliding seat 13 and/or 14.

According to one embodiment, the first and/or second stub axle fixing seat 28 and/or 32 has a first and/or second tub axle seat axis 42 and/or 43.

According to one embodiment, the first and/or second axial sliding seat 13 and/or 14 has a first and/or second guide seat axis 44 and/or 45.

According to one embodiment, the distance between the first and/or second tub axle seat axis 42 and/or 43 and the first and/or second guide seat axis 44 and/or 45 is less than twice the transverse dimension of the first and/or second axial sliding seat 13 and/or 14.

According to one embodiment, the first and/or second bracket fixing seat 29 and/or 33 is circumferentially aligned with at least a portion of the first and/or third pad support surface 17 and/or 22.

According to one embodiment, the brake caliper assembly 2 comprises a support and sliding bracket and stub axle assembly 101 as defined in any of the previously described embodiments, as well as a floating caliper body 3, and a first and a second brake pad 5, 10.

According to one embodiment, the disc brake 51 comprises a brake caliper assembly 2, according to any of the previously described embodiments, and a brake disc 7.

To the embodiments described above, a person skilled in the art, in order to meet contingent and specific needs, may make numerous modifications, adaptations, and replacements of elements with others functionally equivalent, without departing from the scope of the following claims.

### REFERENCE LIST

1 support and sliding bracket
2 brake caliper assembly
3 caliper body
4 first side element
5 first brake pad
6 first braking surface
7 brake disc
8 thrust element
9 second side element
10 second brake pad
11 second braking surface
12 bridge element
13 first axial sliding seat
14 second axial sliding seat
15 first bracket bridge element
16 first connection element
17 first pad support surface
18 second connection element
19 second pad support surface
20 second bracket bridge element
21 third connection element
22 third pad support surface
23 fourth connection element
24 fourth pad support surface
25 stub axle
26 wheel hub
27 first stub axle fixing portion
28 first stub axle fixing seat
29 first bracket fixing seat
30 first stud bolt
31 second stub axle fixing portion
32 second stub axle fixing seat
33 second bracket fixing seat
34 second stud bolt
35 end portion shaped as spherical cap portion
36 stud bolt drive head
37 stud head portion shaped as spherical cap portion
38 seat radius
39 head radius
40 outer bracket crossbar
41 knurled elements
42 first stub axle seat axis
43 second stub axle seat axis
44 first guide seat axis
45 second guide seat axis
46 first bracket seat axis
47 second bracket seat axis
48 first sliding guide
49 second sliding guide
50 inner bracket crossbar
51 disc brake
52 bracket support surface
53 stub axle support surface

### SYMBOLS

A-A axis of rotation or axial direction parallel to the axis of rotation
R-R radial direction orthogonal to axis A-A
C-C circumferential direction orthogonal to A-A and R-R
T-T tangential direction orthogonal to A-A and R-R and tangent to C-C

1. A support and sliding bracket and stub axle assembly (101); said assembly (101) comprises:
at least one support and sliding bracket (1) for a caliper body (3);
said caliper body (3) comprises:
a first side element (4) suitable for facing a first braking surface (6) of a brake disc (7) by means of a first brake pad (5);
said brake disc (7) defining an axial direction (A-A) directed either according or parallel to a rotation axis (X-X) of said brake disc (7); a radial direction (R-R) orthogonal to said axial direction (A-A) and directed radially to said rotation axis (X-X); a circumferential direction (C-C) running along a circumference and directed, at each intersection point between an axial direction (A-A) and a radial direction (R-R), simultaneously orthogonally to said axial direction (A-A) and said radial direction (R-R);
said first side element (4) houses at least one thrust element (8) adapted to bias said first brake pad (5) against said first braking surface (6) to apply a braking action to a vehicle;
said caliper body (3) further comprises a second side element (9) suitable for facing a second braking surface (11) of said brake disc (7) by means of a second brake pad (10);
said caliper body (3) further comprising at least one bridge-like element (12) suitable for being placed straddling the brake disc (7) connecting said first side element (4) to said second side element (9); wherein
said caliper body (3) comprises at least a first axial sliding seat (13) adapted to accommodate a first sliding guide (48) to slide said caliper body (4) axially when said at least one thrust element (8) biases said first pad (5);
said support and sliding bracket (1) comprises at least a first bracket bridge-like element (15) suitable for being placed straddling said brake disc (7); said first bracket bridge-like element (15) comprises a first connection element (16), which forms at least a first pad support surface (17) adapted to receive the support of said first brake pad (5) when abutting against said first braking surface (6) of said brake disc (7); said first bracket bridge-like element (15) comprises a second connection element (18), which forms at least a second pad support surface (19), adapted to receive the support of said second brake pad (10) when abutting against said second braking surface (11) of said brake disc (7);
said support and sliding bracket and stub axle assembly (101) comprises a stub axle (25) adapted to connect to a wheel hub (26); wherein
said stub axle comprises at least a first stub axle fixing portion (27) for the support and sliding bracket (1); wherein
said at least a first stub axle fixing portion (27) comprises a first stub axle fixing seat (28);
said first connection element (16) of said support and sliding bracket (1) comprises a first bracket fixing seat (29);
said support and sliding bracket and stub axle assembly (101) comprises at least a first stud (30); wherein
said at least a first stud (30) comprises a stud control head (36); and wherein either said first stub axle fixing seat (28) or first bracket fixing seat (29) is through-hole and the other is threaded to connect said support and sliding bracket (1) to said stub axle (25) by means of said at least a first stud (30);
characterized in that
either said first stub axle fixing seat (28) or first bracket fixing seat (29) comprises an end portion shaped as spherical cap portion (35) facing said stud control head (36); and
wherein
said stud control head (36) comprises a stud head portion shaped as spherical cap portion

(37) and is adapted to be inserted into said end portion shaped as spherical cap portion (35).

2. An assembly (101) according to claim 1, wherein at least one of the following alternatives is provided
said end portion shaped as spherical cap portion (35) is a spherical sector-shaped seat;
and/or wherein
said stud head portion shaped as spherical cap portion (37) is a spherical sector-shaped head portion.

3. An assembly (101) according to claim 1, wherein
said support and sliding bracket (1) comprises at least a second bracket bridge-like element (20) suitable for being placed straddling said brake disc (7); said second bracket bridge-like element (20) comprises a third connection element (21), which forms at least a third pad support surface (22) adapted to receive the support of said first brake pad (5) when abutting against said first braking surface (6) of said brake disc (7); said second bracket bridge-like element (20) comprises a fourth connection element (23), which forms at least a fourth pad support surface (24) adapted to receive the support of said second brake pad (10) when abutting against said second braking surface (11) of said brake disc

(7).

4. An assembly (101) according to claim 1, wherein
said stub axle comprises at least a second stub axle fixing portion (31) for the support and sliding bracket (1);
said at least a second stub axle fixing portion (31) comprises a second stub axle fixing seat (32);
said third connection element (21) of said support and sliding bracket (1) comprises a second bracket fixing seat (33)
said support and sliding bracket and stub axle assembly (101) comprises at least a second stud (34);
either said second stub axle fixing seat (32) or second bracket fixing seat (33) comprises an end portion shaped as spherical cap portion (35) facing said first stud (30); and wherein said second stud (34) comprises a stud control head (36); and wherein
said stud control head (36) comprises a stud head portion shaped as spherical cap portion (37) and is adapted to be inserted into said end portion shaped as spherical cap portion (35);
and/or wherein
said first and/or second stub axle fixing seat (28 and/or 32) is a threaded seat; and/or wherein
said first and/or second stub axle fixing seat (28 and/or 32) is a through seat; and/or wherein
said first and/or second bracket fixing seat (29 and/or 33) is a through seat; and/or wherein
said first and/or second bracket fixing seat (29 and/or 33) is a threaded seat.

5. An assembly (101) according to claim 1, wherein
said caliper body (4) comprises at least a second axial sliding seat (14) adapted to accommodate a second sliding guide (49) to slide said caliper body (4) axially when said at least one thrust element (8) biases said first pad (5).

6. An assembly (101) according to claim 1, wherein
said end portion shaped as spherical cap portion (35) has a predetermined seat radius (38); and/or wherein
the stud head portion shaped as spherical cap portion (37) has a predetermined head radius (39); and wherein
said predetermined seat radius (38) is smaller than said predetermined head radius (39) so that the contact between said end portion shaped as spherical cap portion (35) and said stud head portion shaped as spherical cap portion (37) occurs in an area limited to substantially one circumference or arc of circumference, allowing for a precise alignment during assembly and allowing the backlashes between the components to be better recovered, and thus said support and sliding bracket (1) to be stressed less, and thus the dimensions thereof and therefore the weight and thus the volume to be reduced.

7. An assembly (101) according to claim 1, wherein
said support and sliding bracket (1) comprises an outer bracket crossbar (40) which connects said second connection element (18) to said fourth connection element (23) so as to stiffen said support and sliding bracket (1), said outer bracket crossbar (40) is suitable for facing said brake disc (7) either directly or interposing said second braking pad (10); and wherein
said support and sliding bracket (1) avoids having any connection which connects said first connection element (16) to said third connection element (21), so as to optimize the performance/weight ratio of the support and sliding bracket (1) so as to reduce the weight of the support and sliding bracket (1), eliminating the problem of coexistence between the inner connection crossbar and the rest of the components present in the caliper, allowing the volume to be reduced and the geometry of the support and sliding bracket (1) to be simplified, increasing the stiffness of the support and sliding bracket (1) as a function of the reduction of the arm between fixings and force application point.

8. An assembly (101) according to claim 1, wherein
said first and/or second bracket fixing seat (29 and/or 33) is directed according to the axial direction (A-A); and wherein
said first and/or second through stub axle fixing seat (28 and/or 32) is directed according to the axial direction (A-A);
or wherein
said first and/or second bracket fixing seat (29 and/or 33) is directed according to the radial direction (R-R); and wherein
said first and/or second through stub axle fixing seat (28 and/or 32) is directed according to the radial direction (R-R);
allowing maximum flexibility of assembly to the stub axle.

9. An assembly (101) according to claim 1, wherein
said support and sliding bracket (1) comprises at least one bracket support surface (52), wherein said bracket support surface (52) is a flat surface;
said stub axle (25) comprises at least one stub axle support surface (53), wherein said bracket support surface (52) is a flat surface;
said stub axle (25) rests on said support and sliding bracket (1) only by means of said bracket support surface (52);
and/or wherein
knurled elements (41) are interposed between said support and sliding bracket (1) and said stub axle (25), in order to allow for the pull reduction of said first and/or second stud (30 and/or 34) in order to reduce the size of the screw itself (30 and/or 34) and thus further the weight of the assembly (101).

10. An assembly (101) according to claim 1, wherein
said first and/or second bracket fixing seat (29 and/or 33) has a first and/or second bracket fixing seat axis (46 and/or 47); and wherein
said first and/or second axial sliding seat (13 and/or 14) has a first and/or second guide seat axis (44 and/or 45); and wherein
the distance between said first and/or second bracket seat axis (46 and/or 47) and said first and/or second guide seat axis (44 and/or 45) is smaller than twice the transverse dimension of said first and/or second axial sliding seat (13 and/or 14);
or wherein
said first and/or second stub axle fixing seat (28 and/or 32) has a first and/or second axle stub axle fixing seat (flat and/or 43); and wherein
said first and/or second axial sliding seat (13 and/or 14) has a first and/or second guide seat axis (44 and/or 45); and wherein
the distance between said first and/or stub axle seat axis (flat and/or 43) and said first and/or second guide seat axis (44 and/or 45) is smaller than twice the transverse dimension of said first and/or second axial sliding seat (13 and/or 14).

11. An assembly (101) according to claim 1, wherein
said first and/or second bracket fixing seat (29 and/or 33) is aligned circumferentially with at least one portion of said first and/or third pad support surface (17 and/or 22).

12. A brake caliper assembly (2) comprising a support and sliding bracket and stub axle assembly (101) according to claim 1 and a floating caliper body (3), as well as a first and a second brake pad (5, 10).

13. A disc brake (51) comprising:
a brake caliper assembly (2), according to claim 12, and a brake disc (7).
